(19) United States
(12) Patent Application Publication
(10) Pub. No.: US 2024/0054471 A1
(43) Pub. Date: Feb. 15, 2024

(54) SYSTEM AND METHOD FOR PROVIDING PUSH PAYMENT TRANSACTION PROCESSING IN A CARD-PRESENT ENVIRONMENT

(71) Applicant: MASTERCARD INTERNATIONAL INCORPORATED, Purchase, NY (US)

(72) Inventors: Christopher Loh, New York, NY (US); Gerardo Cardone, Staten Island, NY (US); John J. Doherty, Brooklyn, NY (US); Luis Filipe de Almeida Ferreira da Silva, Bruxelles (BE); Nishith Shah, Ardsley, NY (US); Robert Gerald Leonard, O?Fallon, MO (US); Smita Sebastian, Scarsdale, NY (US)

(21) Appl. No.: 17/886,918

(22) Filed: Aug. 12, 2022

(51) Int. Cl. G06Q 20/22; G06Q 20/20; G06Q 20/40

(52) U.S. Cl. CPC G06Q 20/223; G06Q 20/204; G06Q 20/4012; G06Q 2220/00

(57) ABSTRACT

Systems and methods for providing push payment transaction processing in a card-present environment are provided. The described push payment transactions processing enables a user having any form factor visiting at a merchant location accepting payment cards to perform push payment transactions. Indeed, push payment transactions can be supported from physical point-of-sale (“POS”) or originate from POS terminals. During the described push payment transaction processing, a merchant acquirer can receive, from a POS terminal, a push payment transaction request comprising at least a transaction type indicating a push payment transaction, transaction information, authorization data, and sender information. In response to receiving the push payment transaction request, the merchant acquirer can generate an application programming interface (API) request package comprising the push payment transaction request; and communicate the API request package to an intermediary platform connected to a payment network.

### BACKGROUND

Payment cards such as credit cards and debit cards are widely used for most forms of financial transactions. These financial transactions can be made in a card-present environment or a card-not-present (“CNP”) environment.

A transaction is only considered to be a card-present transaction if payment details are captured in person, at the time of the sale. A card-present transaction occurs when a payment card is physically swiped, tapped or dipped through a reader or if an EMV chip is processed.

A CNP transaction occurs when neither the cardholder nor the payment card is physically present at the time of the transaction. CNP transactions are most used for online purchases, when a customer buys goods on the Internet or through an e-commerce transaction, but also phone orders, when a customer provides the credit card information over the phone to a business, and mail-order payments by mail or fax.

Another form of a transaction in which a card is not present is a peer-to-peer payment. A peer-to-peer payment allows the transfer of funds between two entities using their individual banking accounts or credit cards through an intermediary platform accessible by a peer-to-peer payment application. These transactions are generally made from a sender's computing device via the peer-to-peer payment application.

Currently, CNP transactions are a major route for credit card fraud because it is difficult for a merchant to verify that the actual cardholder is indeed authorizing a purchase. In addition, for peer-to-peer payment transactions, it may appear that the transaction was approved, but there can be a delay between the transaction on the application and the actual authorization and transfer after which goods may have already changed hands.

### BRIEF SUMMARY

Systems and methods for providing push payment transaction processing in a card-present environment are provided. The described push payment transactions processing enables a user having any form factor visiting at a merchant location accepting payment cards to perform push payment transactions. Indeed, push payment transactions can be supported from physical point-of-sale (“POS”) or originate from POS terminals. As used herein, a “push payment” refers to a disbursement payment or a peer-to-peer (P2P) payment.

During the described push payment transaction processing, a merchant acquirer can receive, from a POS terminal, a push payment transaction request comprising at least a transaction type indicating a push payment transaction, transaction information, authorization data, and sender information. In response to receiving the push payment transaction request, the merchant acquirer can generate an application programming interface (API) request package comprising the push payment transaction request; and communicate the API request package to an intermediary platform connected to a payment network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conventional payment card process in a card-present environment.

FIG. 2 illustrates an example of push payment transaction processing in a card-present environment according to example embodiments of the invention.

FIG. 3 illustrates an example scenario of push payment transaction processing in a card-present environment.

FIG. 4 shows an example process flow diagram for providing push payment transaction processing in a card-present environment according to an embodiment of the invention.

FIG. 5A illustrates components of an example computing device that may be used for contactless payments.

FIG. 5B illustrates components of an example terminal.

FIG. 5C illustrates components of a computing system that may be used in certain embodiments described herein.

### DETAILED DESCRIPTION

Systems and methods for providing push payment transaction processing in a card-present environment are provided. The described push payment transaction processing enables a user having any form factor visiting at a merchant location accepting payment cards to perform push payment transactions. Indeed, push payment transactions can be supported from physical point-of-sale (“POS”) or originate from POS devices.

Currently, payment card users can use their physical payment card or other form factors at a physical point of sale (POS) terminal for purchasing goods and service. Merchants who accept payment cards may only offer purchase with credit payment cards, debit payment cards, and prepaid payment cards. Consumers who want to access more services beyond just purchases at a merchant location, such as, but not limited to, push payment transactions, can either search for provider or need to enroll in their provider's program/or application.

As previously discussed, as used herein, a “push payment” refers to a disbursement payment or a peer-to-peer (P2P) payment. A “disbursement payment” and a “P2P payment” refer to a payment transaction to push funds to a receiving account. Example use cases of a disbursement payment include, but are not limited to, insurance disbursements, rapid merchant settlement, on-demand wages/payouts (e.g., gig economy), pay advance, instant refunds, e-marketplace payouts, and loan disbursements. Example use cases of a P2P payment include, but are not limited to, P2P transfers (e.g., transfers to friends and families, splitting a bill, reimbursing friends, contributing to social causes, and tipping), wallet cash-out, credit card bill pay, account-to-account (A2A) transfers.

As an example, P2P payments allow for the electronic transfer of funds between two users. Conventionally, a mobile phone number, email address, or username is used to initiate the process through an online or mobile P2P payment application in a card-not-present environment. The initiating user of a P2P payment can be either the sender or the receiver.

As an illustrative example of a conventional sender-initiated P2P payment, the sender links funds to a P2P account, either through a bank account or payment card account. To connect to other users and transfer funds, the sender also provides personal contact information, such as a username, a phone number, or an email address. When the sender is ready to initiate a P2P payment, the sender can enter contact information for the recipient, as well as the amount of funds to transfer. The funds are then debited from the sender's account and credited to the recipient's account

The described push payment transaction processing provides an intermediary platform to provide broader range of push payment use cases from a physical POS via application programming interfaces (APIs). Advantageously, the intermediary platform, by leveraging a connection with an authorization network, can accept transaction data needed to qualify for a card-present environment and push payment transfer use cases, which are possible today only in a card-not-present environment. Thus, payment card users will be able to use broader range of money transfer services beyond normal purchases from merchant locations.

Indeed, through the described push payment transaction processing, push payment use cases can become agnostic to any form factor a user is using to perform this transaction at merchant location who accepts payment cards.

The described push payment transaction processing provides additional authentication for push payments performed at a POS terminal. During a push payment transaction, the issuer (or receiving institution) performs an anti-money laundering (AML) check to make sure that the push payment transaction is not terrorist financing or is not money laundering. The issuer also performs a sanctions screening to check that the sender is not a person sanctioned by the U.S. government. To perform these checks, the issuer must be provided with information regarding the sender of the money, such as the name of the sender.

When push payment transactions are performed in a card-present environment at a POS terminal or at an ATM, the acquirer of the transaction can be relieved from requirements of performing the AML and sanctions screening. Instead, the AML and sanctions screening shifts to the receiving institution or the issuer of the transaction since the issuer has the relationship with the cardholder that uses their card at the terminal. Since the issuer is receiving the validation of the pin, as well as the sender information, in the transaction request, the issuer has typically already done the AML and sanction screenings on the sender. The issuer can validate that the information matches their sender who has already been verified under the know your customer (KYC) standards and sanctioned screened.

Through the described push payment transaction processing, the issuer is provided with the authentication data with the transaction to prove the push payment was initiated by a customer of the issuer. Advantageously, providing the issuer with the authentication data in the transaction request to prove the push payment was initiated by a customer of the issuer reduces the number of user interactions and, thus, saves computing resources. Without the described push payment transaction processing, the merchant would have to enter the name of the sender, check the sender's ID, and input that information to be included in the transaction request. Further, if the merchant inputs the sender's information incorrectly, the issuer will decline the transaction. Therefore, by eliminating the need for a merchant to go through the burden of capturing the sender information, faster, more efficient transaction processing can be performed.

### Definitions

A “merchant” refers to a provider of goods or services in exchange for payment. The merchant can be physically present at the sale or remote, such as an online retailer. An “acquirer” refers to a party that processes payments on behalf of the merchant in a payment card transaction. The acquirer can be a bank or other institution associated with the merchant.

An “issuer” refers to a bank or other institution that provides payment cards to the cardholder. A “payment network” refers to a network that routes transaction information to the appropriate issuer. An example of a payment network is the one operated by Mastercard International Incorporated.

As used herein, “payment card” or “card” can be a physical payment card or any non-physical equivalent, such as, for example, a virtual wallet application (also referred to as mobile wallet application) that supports mobile payment via a computing device such as a laptop computer, mobile phone, and wearable computing device (e.g., watch or glasses), and similar computing devices.

A “point-of-sale (POS) terminal” refers to an attended or unattended device including any commercial off-the-shelf (COTS) or other device enabled with mobile point-of-sale (MPOS) functionality, that is in the physical possession of a merchant and is deployed in or at the merchant's premises, and which enables a cardholder to use a card or access device to effect a transaction for the purchase of products or services sold by such merchant or a push payment transaction; or bank branch terminal.

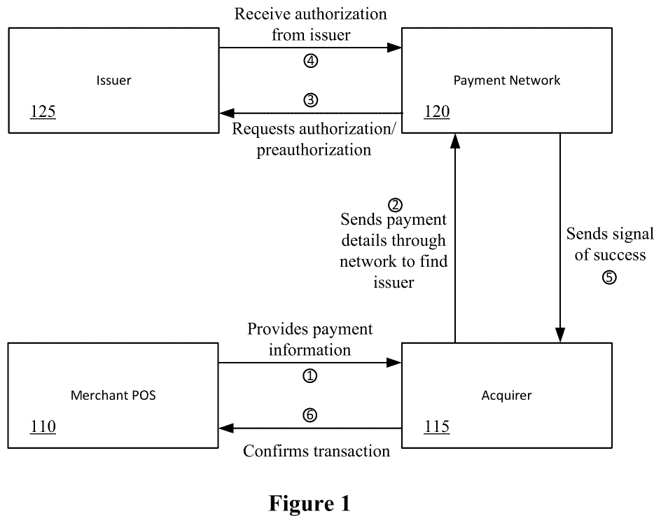

FIG. 1 illustrates an example conventional payment card process in a card-present environment. Referring to FIG. 1, in conventional payment card processes of a card-present environment, there can be communication between a merchant 110, an acquirer 115, a payment network 120, and an issuer 125. These communications can include payment card authorization, clearing, and settlement.

A process of payment card authorization can begin with a customer providing a form of payment to purchase goods or services, for example, by presenting a physical card or a contactless card (e.g., hosted on a mobile device, and available on an e-wallet at a point-of-sale (POS) terminal for the merchant 110. The POS system for the merchant 110 can extract information about the form of payment such as the credit card number, confirmation code, and expiration date, and can also record information about the purchase, such as location, amount, goods type, and a form of verification provided. This information can be provided to an acquirer 115 associated with the merchant 110 as shown in (step 1). The acquirer 115 can, in turn, provide the information to the payment network 120 associated with the form of payment as shown in (step 2) as part of an authorization or preauthorization process.

The payment network 120 can identify an issuing bank, or issuer 125, of the customer's form of payment. The transaction can be logged to aid in later processes, such as clearing and settlement. When the payment network 120 identifies the issuer 125, the payment network 120 can send some of the payment information and request authorization and/or preauthorization on the payment method, as shown in (step 3).

The issuer 125 can respond to the requested authorization or preauthorization. Authorization can entail ensuring that a transaction is legitimate, such as by checking the provided verification, location, and amount. For example, a provided form of verification can be compared against previously given verification, including biometrics, to determine if the customer is the legitimate cardholder. Similarly, the issuer 125 can compare the location of the merchant 110 against typical spending locations for the cardholder to detect fraudulent charges. as another measure, the issuer 125 can determine that a purchase is likely to be too high to be legitimate and flag the purchase as possibly fraudulent. The authorization can also check to see if the card is currently locked or suspended. Pre-authorization can entail determining that a customer has sufficient credit to make the transaction. A credit card pre-authorization is a temporary hold on the funds that last for a period of time (e.g., five days). During the temporary hold, the cardholder cannot spend the money anywhere else, but the charge may not actually show up on their credit card statement. After one or more of these checks are performed, the issuer 125 can accept the transaction and forward a signal of success or failure back to the payment network 120 as shown in (step 4).

Once the signal is received, the payment network 120 can forward the signal to the acquirer 115 as shown in (step 5). The acquirer 115 can then forward the signal back to the merchant 110 as shown in (step 6) to confirm that the transaction has been accepted. Later on, settlement and clearing can occur. In clearing, the payment information can be double checked for accuracy. In settlement, the issuer 125 can transfer funds to the payment network 120; the payment network 120 can then transfer the funds to the acquirer 115. Once the acquirer 115 receives the funds, the funds can be made available to the merchant 110.

Unlike the conventional payment process, the described push payment transaction processing enables a push payment to be received as a payment card transaction, with the effect of crediting funds to the card.

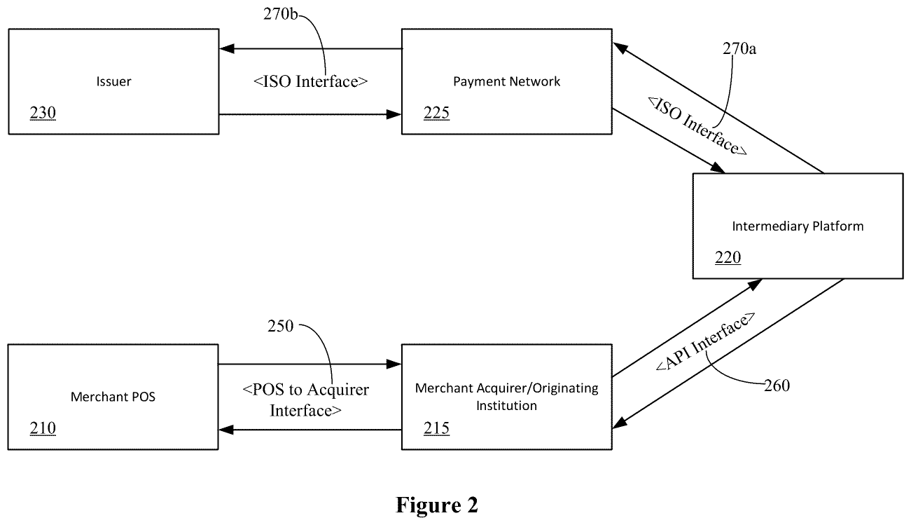

FIG. 2 illustrates an example operating environment for providing push payment transaction processing in a card-present environment according to example embodiments of the invention. Referring to FIG. 2, an example operating environment can include a POS terminal 210 for a merchant, a merchant acquirer 215, an intermediary platform 220, a payment network 225, and an issuer 230.

The POS terminal 210 for a merchant can communicate with the merchant acquirer 215 via a POS to acquirer interface 250 similar to the conventional process. The merchant acquirer 215 may be a conventional acquirer or an originating institution. Unlike in the conventional process described with respect to FIG. 1, merchant acquirer 215 can communicate both with the payment network 225 via conventional protocols (not shown in the figure) and with the intermediary platform 220 via an API interface 260.

The intermediary platform 220 is a push payment platform that connects to a payment card network via an ISO (Independent Sales Organization) interface. The intermediary platform 220 can communicate with the payment network 225 and the payment network 225 and the issuer 230 can communicate via an ISO interface 270 (e.g., ISO interface 270a and 270b). The payment network 225 routes payment information to the appropriate issuer. The issuer 230 can act as a receiving institution and can post funds to their cardholder's accounts.

Components (computing systems, storage resources, and the like) in the operating environment may operate on or in communication with each other over a communication network (not shown). The communication network can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The communication network may include one or more connected networks (e.g., a multi-network environment) including public networks, such as the Internet, and/or private networks such as a secure enterprise private network. Access to the communication network may be provided via one or more wired or wireless access networks as understood by those skilled in the art.

As previously mentioned, communication to and from the components, such as the merchant acquirer and the intermediary platform are carried out via APIs. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

During a push payment transaction in a card-present environment, a user can initiate a push payment using the POS terminal 210. In some cases, the POS terminal 210 can present push payment use case options to the user or the merchant. The push payment options can include, for example, an option for an instant cash-in or cash-out use case, an option for an instant refund use case, and option for a credit card bill payment use case, an option for a P2P transfer use case, or an option for a rapid merchant settlement use case.

The POS terminal 210 can receive transaction information, such as a transaction amount and push payment use case type. The POS terminal 210 can receive an indication of receipt of a payment card. The POS terminal 210 can obtain sender information from the payment card. The sender information can include, for example, a name, address, and account number.

The POS terminal 210 can request a PIN from the user to authenticate that the user is the person at the POS terminal 210 requesting the push payment transaction. Once the user enters the PIN, the POS terminal 210 can receive the PIN and validate the payment card. When the payment card and PIN are validated, authorization data can be generated. The authorization data can include cryptographic information demonstrating the entered PIN is a valid PIN. In some cases, if a PIN block is necessary, the authorization data can include a PIN block.

The POS terminal 210 can package information about the push payment into a push payment transaction request and provide the request to the merchant acquirer 215 via the POS to acquirer interface 250. The push payment transaction request can include a transaction type indicating the transaction is a push payment (e.g., transaction type 28 for a MASTERCARD SEND transaction), transaction information (e.g., transaction amount and push payment use case type), authorization data, merchant information, and the sender information.

The merchant acquirer 215 can receive the push payment transaction request comprising the transaction type indicating the transaction is a push payment (e.g., transaction type 28 for a MASTERCARD SEND transaction), the transaction information (e.g., transaction amount and push payment use case type), the authorization data, the merchant information, and the sender information.

Since the push payment transaction request includes a transaction type in the appropriate field of the message indicating the transaction is a push payment, the merchant acquirer 215 can understand that the transaction is a push payment instead of the typical money sent payment transaction.

The merchant acquirer 215 can generate an API request package that includes the push payment transaction request provided by the POS terminal 210. The merchant acquirer 215 can communicate the API request package to the intermediary platform 220, via the API interface 260.

In some cases, if two-factor authentication is needed, then the intermediary platform 220 can also accommodate PIN data as an authentication data in the transaction request.

In some cases, depending on the region and market, a PIN can be validated offline (by chip) or could be validated online (by an issuer/payment network). If the PIN is validated offline, pin verification results from the POS terminal 210 can be sent through via the intermediary platform 220. If the PIN needs to be validated online, the intermediary platform 220 can forward an encrypted pin block to downstream system

Advantageously, by enabling support of the card-present environment on the intermediary platform, the POS terminal 210 accepting payment cards can offer push payment use cases which are conventionally only available in card-not-present environments.

The intermediary platform 220 can forward the push payment transaction request with all the information received from the POS terminal 210 via the merchant acquirer 215 to the payment network 225 via the ISO interface 270a.

The payment network 225 can send the push payment transaction request (with the transaction type and push payment use case type) to the issuer 230 via the ISO interface 270b.

The issuer 230, upon receiving an authorization request, can credit the account of the user corresponding to the payment card. In some cases, the issuer 230 can credit the account of the user in real-time.

Once the account of the user corresponding to the payment card is credited by the issuer 230, a signal of success can be forwarded from the issuer 230 to the payment network 225 and then to the intermediary platform 220. Once the signal is received, the intermediary platform 220 can forward the signal to the merchant acquirer 215. The merchant acquirer 215 can then forward the signal back to the POS terminal 210 of the merchant to confirm the push payment transaction has been accepted.

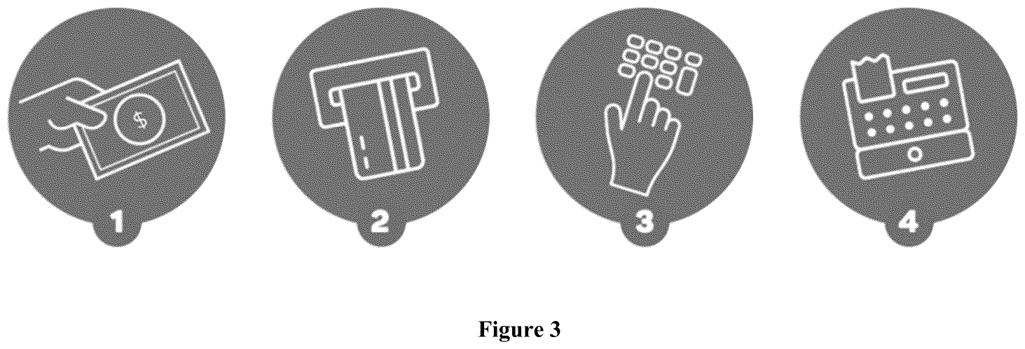

FIG. 3 illustrates an example scenario of push payment transaction processing in a card-present environment. Through the described push payment transaction process, a user can present a payment card (e.g., a physical payment card or a contactless payment card) at a physical merchant POS device or an ATM to make a push payment transaction.

Referring to FIG. 3, the push payment transaction process is initiated when a user makes a request for a push payment at a physical merchant POS terminal (e.g., a card reader device or a contactless terminal). In some cases, a set of push payment options can be presented to the user via the POS terminal. For example, the push payment options can include an option for an instant cash-in or cash-out, an option for an instant refund, and option for a credit card bill payment, an option for a P2P transfer, or an option for a rapid merchant settlement.

In the example scenario, the type of push payment transaction selected by the user is a cash-to-payment card transaction. The user can specify the amount of cash to be deposited into an account linked to a payment card of the user and hand the cash to the merchant (e.g., cashier), as shown in step 1.

The user can present the payment card to the merchant, as shown in step 2. In one case, the user can insert the payment card linked to the account of the user into the card reader device. In another case, the user can tap a contactless payment card on a contactless terminal. The user can then follow the prompts on the card reader device or contactless terminal and enter a personal identification number (PIN), as shown in step 3. Once the push payment transaction is processed, the user can receive a receipt for the deposit, as shown in step 4.

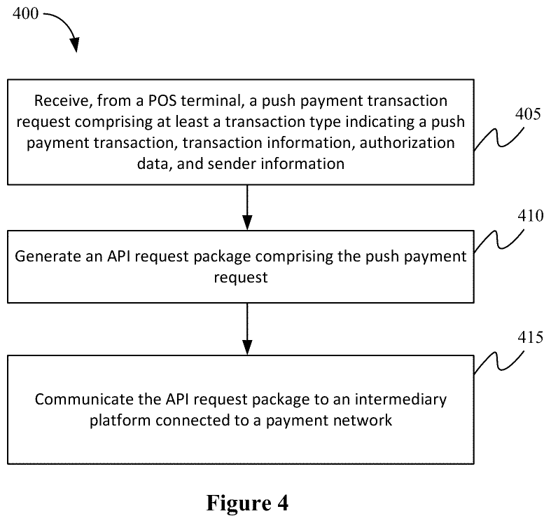

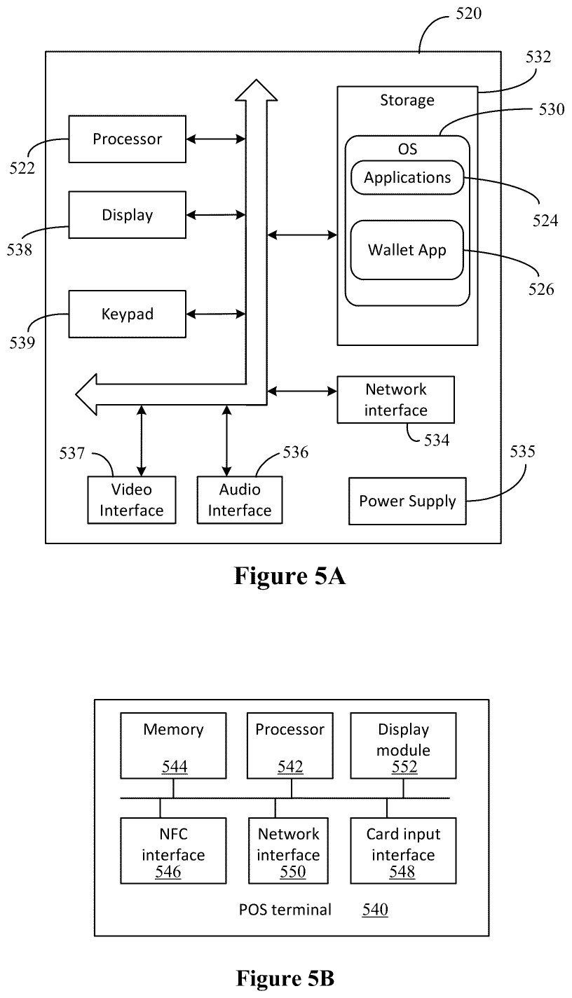

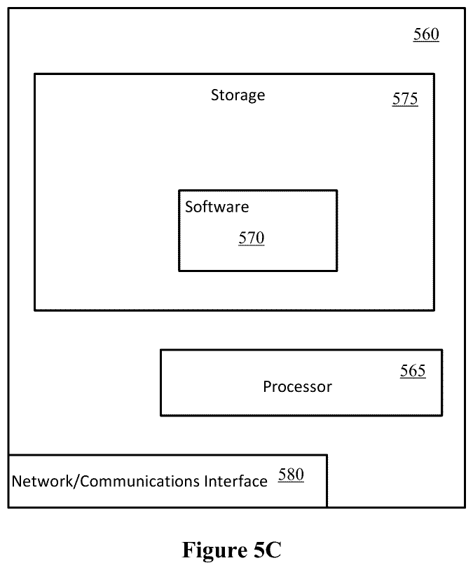

FIG. 4 shows an example process flow diagram for providing push payment transaction processing in a card-present environment according to an embodiment of the invention. Referring to FIG. 4, a merchant acquirer performing process 400 can be implemented by a server embodied as described with respect to computing system 560 shown in FIG. 5C.

Referring to process 400, the merchant acquirer can receive (405), from a POS terminal, a push payment transaction request comprising at least a transaction type indicating a push payment transaction (e.g., transaction type 28), transaction information, authorization data, and sender information.

The transaction information can include, for example, a transaction amount and a push payment use case type. The push payment use case type can include an instant cash-in or cash-out use case type, an instant refund use case type, a credit card bill payment use case type, a P2P transfer use case type, or a rapid merchant settlement use case type.

The sender information can include, for example, a name, address, and account number. The authorization data can include cryptographic information demonstrating the entered PIN is a valid PIN. In some cases, if a PIN block is necessary, the authorization data can include a PIN block.

In response to receiving (405) the push payment transaction request, the merchant acquirer can generate (410) an application programming interface (API) request package comprising the push payment transaction request; and communicate (415) the API request package to an intermediary platform connected to a payment network.

FIG. 5A illustrates components of an example computing device that may be used for contactless payments. Referring to FIG. 5A, computing device 520 can represent, for example, a mobile phone, tablet, smart watch, or other mobile computing device. Computing device 520 can be considered a payment device when used to perform contactless payment processes.

Computing device 520 includes a processor 522 that executes instructions of one or more application programs 524, wallet application 526, and/or operating system 530 that are stored in storage 532. The processor 522 may be, or is included in, a system-on-chip (SoC) along with one or more other components such as sensors (e.g., magnetometer, an ambient light sensor, a proximity sensor, an accelerometer, a gyroscope, a Global Positioning System sensor, temperature sensor, shock sensor) and network connectivity components (e.g., including Radio/network interface 534).

The one or more application programs 524, including wallet application 526, may be stored in storage be loaded into storage 532 and run on or in association with the operating system 530. Examples of application programs include phone dialer programs, email programs, Internet browser programs, messaging programs, game programs, and the like.

In various implementations, data/information stored via the computing device 520 may include data caches stored locally on the device (e.g., in storage 532 or another local storage resource) or the data may be stored on any number of storage media that may be accessed by the device via the network interface 534.

Computing device 520 has a power supply 535, which may be implemented as one or more batteries and/or an energy harvester (ambient-radiation, photovoltaic, piezoelectric, thermoelectric, electrostatic, and the like). Power supply 535 may further include an external power source, such as an AC adapter or a powered docking cradle that supplements or recharges the batteries.

Computing device 520 may also include a network interface 534 that performs the function of transmitting and receiving communications such as radio frequency communications. The network interface 534 facilitates wireless connectivity between computing device 520 and the “outside world,” via a communications carrier or service provider. Transmissions to and from the network interface 534 are conducted under control of the operating system 530, which disseminates communications received by the network interface 534 to the one or more application programs 524 and vice versa. In some cases, near field communication (NFC) or other communication interface devices (not shown) can be included. NFC can be used by computing device 520 for communicating payment and transaction information from the wallet application 526 to a contactless payment supported terminal.

An audio interface 536 can be used to provide audible signals to and receive audible signals from the user. For example, the audio interface 536 can be coupled to speaker to provide audible output and a microphone to receive audible input, such as to facilitate a telephone conversation. A speaker may also be incorporated so that a user may interact with the computing device via voice commands.

Computing device 520 may further include video interface 537 that enables an operation of an optional camera (not shown) to record still images, video stream, and the like. A camera may also be used to capture gestures used for interacting with the computing device.

Visual output can be provided via a display 538. In some cases, the display 538 may be a touch screen display. A keypad 539 can also be included for user input. The keypad 539 may be a physical keypad or a soft keypad generated on display 538.

It should be understood that any computing device implementing computing device 520 may have more or fewer features or functionality than described and is not limited to the configurations described herein.

FIG. 5B illustrates components of an example terminal. Referring to FIG. 5B, a POS terminal 540 can include a processor 542, memory 544, a payment interface embodied as an NFC interface 546 and/or card input interface 548, a network interface 550, and display module 552. The POS terminal 540 may have more or fewer components depending on implementation. The memory 544 can store instructions that, when executed by processor 542, direct the POS terminal to perform various processes. The NFC interface 546 supports contactless payment communications with a device and the card input interface 548 supports insertion of a payment card for contact-based payment communications with a device. The POS terminal 540 can communicate with other devices and systems, including a protection server, via the network interface 550. Information (including whether a transaction was approved or declined) can be output for viewing on the display module 552.

FIG. 5C illustrates components of a computing system that may be used in certain embodiments described herein. Referring to FIG. 5C, system 560 may be implemented within a single computing device or distributed across multiple computing devices or sub-systems that cooperate in executing program instructions. The system 560 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 560 can include a processing system 565, which may include one or more processors and/or other circuitry that retrieves and executes software 570 from storage system 575. Processing system 565 may be implemented within a single processing device but may also be distributed across multiple processing devices or sub-systems that cooperate in executing program instructions.

Storage system(s) 575 can include any computer readable storage media readable by processing system 565 and capable of storing software 570. Storage system 575 may be implemented as a single storage device but may also be implemented across multiple storage devices or sub-systems co-located or distributed relative to each other. Storage system 575 may include additional elements, such as a controller, capable of communicating with processing system 565. Storage system 575 may also include storage devices and/or sub-systems on which data is stored. System 560 may access one or more storage resources in order to access information to carry out any of the processes indicated by software 570.

Software 570, including routines for performing processes, such as process 400, may be implemented in program instructions and among other functions may, when executed by system 560 in general or processing system 565 in particular, direct the system 560 or processing system 565 to operate as described herein, for example, for an acquirer performing process 400.

In embodiments where the system 560 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 580 may be included, providing communication connections and devices that allow for communication between system 560 and other computing systems (not shown) over a communication network or collection of networks (not shown) or the air.

In some embodiments, system 560 may host one or more virtual machines.

Alternatively, or in addition, the functionality, methods, and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A computing device comprising:
a processor;
a storage device; and
instructions stored in the storage device that when executed by the processor, direct the computing device to:
receive, from a point of sale (POS) terminal, a push payment transaction request comprising at least a transaction type indicating a push payment transaction, transaction information, authorization data, and sender information;
in response to receiving the push payment transaction request, generate an application programming interface (API) request package comprising the push payment transaction request; and
communicate the API request package to an intermediary platform connected to a payment network.

2. The computing device of claim 1, wherein the intermediary platform is a push payment platform and connects to the payment network via an ISO interface.

3. The computing device of claim 1, wherein the instructions further direct the computing device to:
receive a signal of success from the intermediary platform; and
provide the signal of success to the POS terminal to confirm the push payment transaction has been accepted.

4. The computing device of claim 1, wherein the transaction information comprises a transaction amount and a push payment use case type.

5. The computing device of claim 4, wherein the push payment use case type comprises a rapid merchant settlement use case, an instant refund use case, a peer-to-peer (P2P) transfer use case, or a credit card bill payment use case.

6. The computing device of claim 1, wherein the authorization data comprises cryptographic information demonstrating an entered personal identification number (PIN) is valid.

7. The computing device of claim 1, wherein the POS terminal is a merchant POS terminal in a card-present environment,
wherein the instructions to receive the push payment transaction request from the POS terminal direct the computing device to receive the push payment transaction request via a POS to acquirer interface.

8. The computing device of claim 1, wherein the instructions to communicate the API request package to the intermediary platform connected to the payment network direct the computing device to communicate the API request package via an API interface.

9. One or more computer-readable storage media having instructions stored thereon that when executed, direct a processing system to:
receive, from a POS terminal, a push payment transaction request comprising at least a transaction type indicating a push payment transaction, transaction information, authorization data, and sender information;
in response to receiving the push payment transaction request, generate an API request package comprising the push payment transaction request; and
communicate the API request package to an intermediary platform connected to a payment network.

10. The media of claim 9, wherein the intermediary platform is a push payment platform and connects to the payment network via an ISO interface.

11. The media of claim 9, wherein the transaction information comprises a transaction amount and a push payment use case type, the push payment use case type being a rapid merchant settlement use case, an instant refund use case, a P2P transfer use case, or a credit card bill payment use case.

12. The media of claim 9, wherein the authorization data comprises cryptographic information demonstrating an entered personal identification number (PIN) is valid.

13. The media of claim 9, wherein the POS terminal is a merchant POS terminal in a card-present environment,
wherein the instructions to receive the push payment transaction request from the POS terminal direct the processing system to receive the push payment transaction request via a POS to acquirer interface.

14. The media of claim 9, wherein the instructions to communicate the API request package to the intermediary platform connected to the payment network direct the processing system to communicate the API request package via an API interface.

15. A method comprising:
receiving, from a POS terminal, a push payment transaction request comprising at least a transaction type indicating a push payment transaction, transaction information, authorization data, and sender information;
in response to receiving the push payment transaction request, generating an API request package comprising the push payment transaction request; and
communicating the API request package to an intermediary platform connected to a payment network.

16. The method of claim 15, wherein the intermediary platform is a push payment platform and connects to the payment network via an ISO interface.

17. The method of claim 15, wherein the transaction information comprises a transaction amount and a push payment use case type, the push payment use case type being a rapid merchant settlement use case, an instant refund use case, a P2P transfer use case, or a credit card bill payment use case.

18. The method of claim 15, wherein the authorization data comprises cryptographic information demonstrating an entered personal identification number (PIN) is valid.

19. The method of claim 15, wherein the POS terminal is a merchant POS terminal in a card-present environment and the push payment transaction request is received via a POS to acquirer interface.

20. The method of claim 15, wherein the API request package is communicated to the intermediary platform via an API interface.
